(19) United States
(12) Patent Application Publication
(10) Pub. No.: US 2018/0306017 A1
(43) Pub. Date: Oct. 25, 2018

(54) Improving Hydrocarbon Production from a Well

(71) Applicant: James M Savage, Ragley, LA (US)

(72) Inventor: James M Savage, Ragley, LA (US)

(21) Appl. No.: 15/771,274

(22) PCT Filed: Oct. 26, 2016
(86) PCT No.: PCT/US16/58958

§ 371 Date: Apr. 26, 2018

Related U.S. Application Data
(60) Provisional application No. 62/285,285, filed on Oct. 26, 2015.

(51) Int. Cl. E21B 43/32; C09K 8/46; C09K 8/44; E21B 33/138; E21B 7/04

(52) U.S. Cl. CPC E21B 43/32; C09K 8/46; E21B 7/04; E21B 33/138; C09K 8/44

(57) ABSTRACT

A method to reduce water production into a wellbore from a subterranean formation that includes placing a blocking material into the subterranean formation, forming at least one radially-oriented borehole exiting the wellbore at between 45 to about 90 degrees from the wellbore into the subterranean formation, and producing hydrocarbons through the at least one radially-oriented borehole.

### CROSS-REFERENCE TO RELATED APPLICATIONS

The present filing claims priority to U.S. provisional patent application 62/285,285 filed on Oct. 26, 2015.

### FIELD

The present disclosure generally relates to drilling wellbores into a subterranean formation and more particularly to utilizing short radius lateral drilling in procedures to alter hydrocarbon and water production in existing wells.

### BACKGROUND

Natural resources such as oil and gas located in a subterranean formation can be recovered by drilling a wellbore down to the subterranean formation, typically while circulating a drilling fluid in the wellbore. The wellbore is drilled with the use of a tool string consisting of drill pipe, various tools and having a drill bit on the distal end. During the drilling of the wellbore drilling fluid is typically circulated through the tool string and the drill bit and returns up the annulus between the tool string and the wellbore. After the wellbore is drilled typically the tool string is pulled out of the wellbore and a string of pipe, e.g., casing, can be run in the wellbore. The drilling fluid is then usually circulated downwardly through the interior of the pipe and upwardly through the annulus between the exterior of the pipe and the walls of the wellbore, although other methodologies are known in the art.

Slurries such as hydraulic cement compositions are commonly employed in the drilling, completion and repair of oil and gas wells. For example, hydraulic cement compositions are utilized in primary cementing operations whereby strings of pipe such as casing are cemented into wellbores. In performing primary cementing, a hydraulic cement composition is pumped into the annular space between the walls of a wellbore and the exterior surfaces of the casing. The cement composition is allowed to set in the annular space, thus forming an annular sheath of hardened substantially impermeable cement. This cement sheath physically supports and positions the casing relative to the walls of the wellbore and bonds the exterior surfaces of the casing string to the walls of the wellbore. The cement sheath prevents the unwanted migration of fluids between zones or formations penetrated by the wellbore.

Once the cement sheath has hardened sufficiently the casing is typically perforated at a desired depth, the well may have additional completion operations such as acidizing and fracturing performed. The desired depth is chosen based on the location of oil, gas and water within the formation. In a typical formation in an undisturbed state the oil, gas and water in these zones are vertically segregated based on their respective densities. For example in a formation there can be a gas bearing zone located at the highest elevation, an oil bearing zone located below the gas, and a water bearing zone located below the oil bearing zone. For a preferential oil producing well the perforations may be targeted to an upper portion of the oil bearing zone, in an effort to avoid water production when the well is produced.

Given the proximity of water to many hydrocarbon-bearing zones, co-produced water is one of the major problems facing oil and gas producers around the world. Indeed, as cumulatively more hydrocarbons are extracted from a reservoir and as that reservoir is produced longer, increasingly high water-cuts are typically encountered. Produced water to oil ratios are about 3:1 worldwide, and are closer to 10:1 in the United States. In the U.S. this means that for every 1 barrel of oil that is produced approximately 10 of water are co-produced. Not surprisingly, many wells become uneconomical because of the excessive lifting and disposal costs associated with this excessive water production.

Recognizing that water typically subtends oil in their reservoirs, oil and gas operators typically complete their wells in an upper portion of a hydrocarbon containing formation. This practice helps delay the influx of water versus opening-up the entire hydrocarbon containing formation to the wellbore. But this strategy typically just delays the water production, as the water seems to inevitable come.

The causes for excessive water production are varied, but some of the most common causes include: the rising water level in the zone; leaks behind the casing; fractures in the zone; high-permeability streaks; water flooding; and the typically lower viscosity and greater mobility of water to oil. The section below provides brief explanations of these dynamics and will be helpful in our understanding of the benefit of this disclosure. a) As hydrocarbons are produced from a reservoir the water level in that reservoir tends to rise. Basically, the water “fills the void” left behind as the hydrocarbons are produced. And if the reservoir has a strong water-drive, this situation only hastens the water production. b) A poor cement bond between either the casing or the formation face can allow water to migrate into the wellbore through the perforations. c) Many reservoir rocks are naturally fractured and often they are hydraulically fractured to further stimulate their hydrocarbon production. The exact pathways of these fractures, whether naturally occurring or created during completion operations, are difficult to know and control. As fractures can have 100s or 1000s of time greater permeability than the matrix rock, if these fractures connect vertically to a subtending water zone they can serve as easy conduits for water intrusion. d) Hydrocarbon bearing zones are rarely homogenous and can have widely varying porosity and permeability. If a high permeability zone is in contact with a water zone or is fed by a fracture in communication with one, it is possible for this high permeability zone to feed excessive water into the well. e) As the pressure and hydrocarbon production in a reservoir falls, it is common for the reservoir to be put on some form of water flood. Frequently, the water finds a high permeability streak or fracture and essentially flows within this channel through the reservoir rock to the production well. f) Most oils are more viscous than water, meaning water is inherently easier to move than oil. In addition, reservoirs rock can have adverse wettability, meaning that the rock preferentially clings to the oil, while allowing the water to more freely pass.

Another phenomenon, referred to as water coning, is frequently encountered when producing hydrocarbons. Water coning occurs in the near wellbore area and involves water being pulled up into the perforations or open-hole section of the well. Essentially, the water invades the hydrocarbon bearing zone forming a cone-like shape around the wellbore. In horizontal wells, there's a similar phenomenon, referred to as water cusping. In the interest of simplicity, hereafter we may sometimes refer to the aforementioned problems simply as “water intrusion” or “water coning”.

The problem of water coning can also be aggravated by any near wellbore damage. Over time, near wellbore damage, caused by such things as fines migration, paraffin, emulsions and asphaltenes can plug the pore space and pore throats around the wellbore. In addition, certain formations have clays that can swell in the presence of water. Whatever the case, this plugging can make it more difficult for the well to drain hydrocarbons from the laterally-oriented portions of the reservoir (where the oil tends to be situated) and instead, it is easier for the well to pull in water from below.

One water-control option available to operators is to produce the well below the critical rate. The critical rate is that production level at which water gets pulled into the well. This option obviously presents a dilemma to the well operator: they can avoid the unwanted water, but it comes at the expense of reduced hydrocarbon production. In practice and to improve the economics of their well, most operators produce above the critical rate and deal with the excess water that is produced.

Current industry practices that attempt to mitigate water intrusion include: a) squeezing cement into the zone and re-perforating; b) pumping specialized chemicals that reduce the relative permeability of water vs oil in the zone; c) placing microbial treatments into the reservoir in an effort to block high-flow water pathways; d) mechanically isolating high-water producing zones or perforations via a packer; e) abandoning the high water-producing zone and moving to a new depth in the well; and f) abandoning the well.

Each of these mitigations has drawbacks well-known to practitioners in the industry. A treatment that is too small (or a misplaced treatment) and the water coning problem is not adequately addressed; while, too much of a treatment (or a misplaced treatment) and hydrocarbon production can be severely impaired. The well operator has very limited options to re-initiate production if the treatment turns out to be too much. For example, if a cement squeeze causes swelling of clay or reaches say 3 or 4 feet into the reservoir. Re-perforating the well is an often-tried option, but perforations do not reach very far into the reservoir, typically 1-2 feet in-situ. The well could be re-fractured but the induced fracture might extend right back into the water. Basically, if the unsuccessful treatment reaches past about 3 feet into the reservoir, it often becomes practically impossible to safely re-establish good in-flow from the zone.

Because of the very real risk of severely impairing a good zone, many operators will take a very conservative approach to addressing water intrusion. This understandable approach, however, often means the remediation measure are inadequately or short-lived. All too often, the final result is that the well operator ends-up prematurely abandoning the well (or zone) rendered uneconomical because of excessive water production. Meanwhile, they typically leave behind the vast majority of the oil.

Thus, a need exists for a practical method to treat a well or zone for excessive water production.

### SUMMARY

The present invention relates to a method to ultimately improve desired hydrocarbon production from oil and gas zones by first taking deliberate measures that can “kill the well”. This normally unthinkable step is taken in order to stop production of the unwanted material, normally water. As part of this procedure, radial boreholes are then formed in the formation in order to re-establish deep reaching drainage tunnels that go far beyond the now severely-impaired or no-flow barrier that has been placed around the wellbore.

The treatment methods to kill or severely impair flow from some or all of the zone may include pumping any number of cements, waxes, chemical fluids, gels, polymers or similar flow-impairing material into the zone. With this procedure one can become extremely aggressive in placing a virtually or totally impermeable barrier to water production, even at the expense of blocking all hydrocarbon production. One can take such a drastic measure because of the ability to re-establish robust in-flow that reaches beyond the aggressive flow barrier.

Of particular note is the fact that this invention can dramatically reduce water production and accompanying water handling and disposal costs. It can enable significantly increased hydrocarbon production, production that might otherwise be uneconomical to recover.

### BRIEF DESCRIPTION OF DRAWINGS

The accompanying views of the drawing are incorporated into and form a part of the specification to illustrate several aspects and examples of the present disclosure, wherein like reference numbers refer to like parts throughout the figures of the drawing. These figures together with the description serve to explain the general principles of the disclosure. The figures are only for the purpose of illustrating preferred and alternative examples of how the various aspects of the disclosure can be made and used and are not to be construed as limiting the disclosure to only the illustrated and described examples. The various advantages and features of the various aspects of the present disclosure will be apparent from a consideration of the figures.

FIG. 1a illustrates a typical, perforated wellbore where no water intrusion problem exists.

FIG. 1b illustrates the same wellbore as FIG. 1a but the water zone has invaded into the oilzone forming a water cone with water entering the perforations.

FIG. 2a illustrates the same wellbore as FIGS. 1a and 1b, but wherein an impermeable barrier has been placed, blocking all flow and in affect “killing” the well.

FIG. 2b illustrates the same wellbore as FIG. 2a but two radial boreholes have been drilled through the impermeable barrier to re-establish oil inflow to the well.

FIG. 3a illustrates fractures that are channeling water into a well from a subtending water zone via the lower perforations in the oil zone.

FIG. 3b illustrates the same wellbore as FIG. 3a but a flow barrier has been placed into the oil zone and fractures through the lower perforations. To re-establish robust drainage from the oil zone into the well, laterals have been drilled both through and above the flow barrier.

FIG. 4 illustrates a high permeability hydrocarbon zone with a problematic subtending water zone. Downward oriented laterals have been drilled near in the lower section of the oil zone and flow blocking material has been pump through an isolation packer to form a sort of “skirt” or “plug” around the wellbore to prevent water coning. Once the isolation packer is removed, oil can be produced through the upper perforations.

FIG. 5a illustrates a wellbore with an overriding gas cap that is invading into the well both by gas coning and a problematic fracture leading from a perforation into the gas gap.

FIG. 5b illustrates the well as FIG. 5a but a flow stopping treatment has been placed into the oil zone through the perforations and has also plugged the problematic fracture. Oil inflow to the well has been re-established by a single lateral formed through the flow blocking treatment.

### DETAILED DESCRIPTION

In a first step, this invention involves treating a well with a flow-blocking treatment in such a way that the well (or zone) can be “killed” or oil production otherwise severely impaired.

Several deliberate actions can be under-taken to accomplish this first step. For example, this aggressive treatment may entail any combination of: a) placing flow-blocking materials in appreciably higher strengths or concentrations than is conventional; b) placing these materials into the reservoir in much higher quantities than best practices suggest; c) placing these materials in otherwise irreversible treatments; d) placing these materials deeper into the reservoir than normal; e) placing these materials in the hydrocarbon bearing portion of the zone, itself, f) placing a combination of materials into the reservoir that is beyond best practices for the specific zone due to its severe risk of impairing the oil production from that zone.

These measures can be done by pumping or squeezing a wide variety of flow-diverting or flow-blocking materials out of the wellbore. For example, pumping any number of: cements; waxes; gels; polymers; epoxies; cross-linked polymer; emulsions; microbes; or other relative permeability modifiers (RPMs) into the zone. Besides changes to the composition or mix of these flow-blocking or flow-diverting materials, higher pressure and/or longer treatments can be pumped so as to assure that these treatments penetrate deeper into the target water-saturated zones and optionally into the oil-saturated zone itself

To better execute these treatments one can use an isolation packer. The packer could be run on the end of coiled tubing or could be set on production or upset tubing. Additionally, one could use multiple packers to isolate specific zones for treatment. This technology and its processes are well known to those in the industry.

In these aggressive procedures, the penetration of the flow-blocking material will typically reach out deep into the zone. Most notably, these treatments may extend far beyond the 1 to 3 feet in-situ distance that perforations can typically reach. These aggressive flow-negating treatments can extend beyond the distance that where flow can be re-established by perforating.

Because of the aggressive steps above, this flow-blocking materials can: a) reduce behind-the-pipe flow taking place between at the casing-cement interface or the cement-formation interface; b) intrude into and block flow from nearby fractures, whether they those fractures be natural or man-made; c) block flow thru the matrix in the vicinity of the wellbore, whether that portion of the matrix is predominately saturated by oil, water or gas; d) intrude into and reduce or stop flow from high permeability streaks or strata; or e) can cause clays to swell on account of utilizing fresh water pumped into the zone.

In taking the above measures, the well operator has essentially produced a zone of severely reduced flow in the critical well area. This zone can be envisioned as an impermeable cylinder situated around the wellbore, but in reality it is far more likely to be to take on an amorphous shaped that preferentially follows fractures and high permeability streaks. At the same time, because of the more aggressive treatment, it is also likely for this treatment to penetrate into the matrix itself.

A further aspect to this disclosure is that these treatments might not only be pumped through lower perforations that have water out, but they may be pumped through mid-level perforations adjacent to oil saturated zones, or even through all of the perforations, whether water or hydrocarbon bearing.

Depending upon the individual reservoir and material properties and degree to which the materials block flow, the pump times and pumping pressures/rates may generally place these materials relatively short distances into the reservoir or they may penetrate dozens of feet or more. The flow-blocking materials may be selected that have properties that encourage these materials to preferentially invade water-saturated zones. For example, one may select denser materials (so as to tend downward toward subtending water zones), materials that are miscible or hydrophilic with water or which have preferred wettability characteristics in water-saturated zones.

To re-establish production, we use ultra-short radius lateral drilling to form one or more radial boreholes that extend through or above the water-blocking materials.

The drilling of a horizontal well typically involves the drilling of an initial vertical well and then a lateral extending from the vertical well which arcs as it deviates away from vertical until it reaches a horizontal or near horizontal orientation into the subterranean formation.

In ultra-short radius drilling procedures specialized tools are swept around the tight radius of a whipstock and are then used to form one or more boreholes radiating outward from the wellbore and into the subterranean formation. Ultra-short radius lateral drilling is distinct from conventional horizontal and coil tubing drilling. In conventional horizontal and coil tubing drilling procedures, the drilling tools are swept around a radius or “heel” that is hundreds or even thousands of feet in size. In these procedures virtually all of the change in direction takes place outside of the wellbore proper. By contrast, in short radius drilling, the primary change of direction occurs inside of the wellbore itself, that is, it occurs in the matter of a few inches.

As wellbores suited to this procedure commonly have a diameter of between about 4½″ to 7″, this equates to radii of between about 2¼″ to about 3½″ inches. In many short radius lateral drilling procedures a full 90 degree arc or “heel” is completed within the wellbore, within about 0.25 ft (3 inches). This contrasts markedly with coiled tubing drilling, which often requires on the order of 250 feet and with conventional horizontal drilling which can utilize on the order of 2,500 feet for a full 90 degree heel. Conventional horizontal drilling technologies operate at a scale 3 to 4 orders of magnitude larger than those of short radius lateral drilling technologies.

The process of “radial drilling” entails forming extended boreholes (e.g. at least 5 feet) in earthen formations that extend outward from a primary wellbore. In radial drilling, the exit angle from the primary wellbore ranges from 45 degrees to slightly over 90 degrees and form a “radial borehole”. Radial boreholes have extraordinarily high “build-angles” for the tools. That is, these build-angles are diametrically opposed to those found in conventional rig-based or coiled tubing-based horizontal drilling procedures. In these arts, the tool-string exits the wellbore at extremely shallow exit angles, typically no more than 3 to 5 degrees.

Radial drilling procedures typically include the placement of a whipstock at a target depth inside the wellbore. Sometimes the whipstock is run on the end of upset or production tubing. Radial drilling related tools and procedures can be used on open-hole completed or cased hole wells. If no opening is present in a cased well, access to the formation is sometimes gained by milling out a section of the metal well casing. More commonly, however, a specialized tool-string is moved down the wellbore and are used to form a small round hole in the casing. In known practices, the tools used to form the hole in the casing are then retracted and a separate formation-drilling tool is inserted downhole. The formation-drilling tools are then directed by the whipstock toward the earthen formation or target zone (through the existing hole in the casing). Obviously, in open-hole completed wells, there is no need to cut the casing. Regardless of whether the well is cased or open hole completed, the tools are manipulated by some form of control-line. The control-line might be a wireline unit, a coil tubing unit (CTU) or jointed-tubing.

It is also worth noting that these ultra-short radius lateral drilling systems exit the wellbore at between 45 to slightly over 90 degrees, which differs drastically with conventional horizontal drilling technologies which typically exit at less than 5 degrees, and sometimes closer to 1 degree.

A variety of tools can be used to form the lateral boreholes in ultra-short radius lateral drilling procedures. For example, sometimes a high-pressure jetting nozzle-head is used in an attempt to erode or dissolve the rock. An example of this method can be found in U.S. Pat. No. 8,424,620 by Savage. In other cases a motor drives a sort of flexible mechanical drilling shaft and attached cutting head as described in U.S. patent application Ser. No. 13/226,489 and U.S. Patent Application 61/179,070 also by Savage and incorporated herein by reference. In yet other cases ballistic, exothermic reactions, lasers or other means can be employed to form the lateral.

Having pumped the flow-blocking materials into the well the next step is to drill one or more ultra-short radius lateral(s) through the slug/plug of no-flow and into the target zone. Often this will be done by forming the lateral at or near the highest set of perforations, but can be drilled through the slug/plug of no-flow. Depending upon the hardness of the material that was placed it may be the case that the best-suited ultra-short radius lateral technology is one of the aforementioned mechanical drilling systems. For example, as known jetting systems cannot reliably cut cement, mechanical drilling systems may be the only options for forming a drainage borehole through a cement squeeze.

The step of re-establishing communication with the hydrocarbon zone will typically entail placing multiple ultra-short radius laterals; moreover, each of these will extend beyond the limited area reached by perforating (e.g. 1-3 ft). For example, drilling multiple ultra-short radius laterals that radiate outward from about 5 to over 50 feet, thereby forming a sort of a wagon-wheel pattern of drainage spokes.

Besides drilling past the deliberately-impaired near wellbore area, these drainage tunnels provide significantly improved communication between the payzone and wellbore due to their sizable surface area. In embodiments this approach can significantly improve the pressure gradient around the wellbore so as to prefer pulling laterally (where the oil tends to resides), rather than upwards/vertically (i.e. from subtending water zones).

A particularly promising application for the kill-and-drill concept above pertains to fractured wells. As explained above, fractures can provide 100s or 1000s of times greater flow than the matrix. If these fractures extend into a water-saturated zone, however, instead of being an asset the fractures becomes a detriment. In these kill-and-drill applications one would pump water-blocking materials out the wellbore and through the fractures. As water typically subtends oil zones, this water-blocking material could be of a higher density than the water (or brine) so that as it went outward from the wellbore it preferentially moved downward. One would then reestablish robust hydrocarbon inflow via ultra-short radius laterals emplaced through or above the water-blocking materials.

In a variant of the kill-and-drill concept presented earlier one could performs what might be called a “drill-kill-and-drill” procedure. In this procedure, ultra-short radius lateral boreholes near or below the water boundary can be formed. Ideally, several of these radials would be created to form a series of spokes (around the wellbore) like a wagon-wheel. Again, these radials boreholes would extend anywhere from about 5 to over 50 feet. Flow diverting or flow-blocking material, like those described above, would then be pumped out these lateral and into the surrounding zone. In this procedure, this set of laterals would essentially serve as “injection laterals”. That is, they would serve as a conduit to emplacing the flow-blocking materials into the reservoir. Such a step would form an aggressive, potentially deep-reaching flow-barrier in the well's vicinity. Ultra-short radius laterals would then be formed in a higher portion of the payzone. These “production laterals” would then serve to re-establish hydrocarbon inflow. By following this approach the well operator can form a sort of pancake or cylinder of no-flow near the problematic water zone.

While the above discussion might suggest that all of the laterals radiate outward at 90 degrees to the wellbore, this is not a necessity. For example, in the lower laterals of the drill-kill-and-drill approach discussed above could extend downward at any angle, such as from 90 degrees to 20 degrees, or from 80 degrees to 30 degrees, or from 70 degrees to 40 degrees, or from 60 degrees to 50 degrees. Thus, when pumping the water blocking material, a sort of no-flow “cone” or “skirt” would be emplaced. Essentially where there was a water cone before, we have now placed a no-flow cone extending 5, 10, 20 feet or more out from the wellbore.

A further variant of the drill-kill-and-drill approach discussed above eliminates the last step, the one where production laterals are created. This process could have applicability to thick, high permeability reservoirs with severe water intrusion. Take for example a 25 foot thick zone with 500 milli-darcy of permeability subtended by a 50 foot heave water drive zone. A series of ultra-short radius laterals extending outward like spokes can be drilled. These laterals could be positioned slightly above the oil water contact (e.g. 5 feet above) and might extend outward, for example 10 to 30 feet. Flow blocking material then be pumped out these laterals, forming the no-flow cylinder or skirt. As there is still plenty of reservoir contact of high permeability above (e.g. 20 feet) the no-flow skirt, it may not be necessary to place additional ultra-short radius laterals to re-establish robust inflow. One might call this variant “drill-and-kill-and-produce” (from above).

While the focus of discussions so far have pertained to blocking water from below, in certain situations the intrusion problem may be from above. For example, a water zone separated by a thin or poor cap-rock may allowing unwater materials to come in from above the perforations. In addition, as gas is lighter than oil, it will naturally sit atop an oil zone. Like water production, producing gas might be undesirable. This can be particularly frustrating if the produced gas must be flared. Worse still is the situation where the reservoir has gas drive. In these cases as gas enters the wellbore, it reduces the gas cap and the reservoir's drive. As such it may be desirable to place a flow control barrier toward the top of an oil zone in order to reduce or stop unwanted gas production. In these cases, a generally similar concept to that described above scenarios can be employed. Obviously, the key difference is the no-flow barrier would be placed toward the top of the zone rather than toward the bottom, as is typically the case when addressing water intrusion. A further difference is that to ensure the optimal placement of the flow-blocking material it may be necessary to utilize low-density material. That is, one would generally want this material to stay on top of the in-situ oil, staying near or invaded the higher-up gas zone. At this point, the other obvious difference is that instead of preferentially positioning the ultra-short radius borehole(s) used for production higher-up the zone, one would need to come lower down (into the oil saturated zone). That is, one would form the “production lateral(s)” below the no-flow barrier, i.e. near or below the gas-oil contact.

While each of the above scenarios entails a slightly different process, each differs significantly from current industry norms and best practices. In each of the procedures, deliberate and aggressive steps are taken to shut-off flow of unwanted product into the wellbore including, if necessary, also all hydrocarbon flow. These procedures do not merely address the immediate wellbore area, the distance typically delineated by the 2-3 foot depth that perforations can reach into the zone; instead, they involve any number of decisive steps to assure a cessation of unwanted material by willingly extending deeper into the zone. Moreover, in all but the drill-and-kill-and-produce approach (suitable to high permeability reservoirs), each of the procedures described above entails utilizing ultra-short radius laterals to re-establish robust in-flow of oil.

While the above discussion has primarily used language applicable to vertical wellbores, similar principals apply to horizontal wells. Moreover, while the above discussion centers around working-over or re-completing existing wells, this technology can also be used as a pro-active method to complete new wells. For example, one could produce the no-flow zone around a new wellbore in anticipation of future water and or gas intrusion.

As the flow-diverting or flow-blocking materials described above can have widely varying viscosities and properties, we sometimes simply call them “materials”. As part of the success of this approach entails placing these materials into the reservoir, a further discussion is warranted about how these materials are activated. As is familiar to those in the industry, a number of methods can be used to “trigger” the setting of the flow blocking material. For example, the material may harden or set by virtue of: the passage of time; change in pH; by changes in temperature; changes in pressure; or by contact with other chemicals pumped into or already present in downhole. Optionally combinations of the foregoing can set the materials.

In some instances it may be possible to simply drop the flow-blocking material down the wellbore instead of formally pumping them. These methods are intended to be within the scope of this disclosure. It should also be noted that we use the term lateral, radial and borehole, tunnel and similar terms to refer to the laterally extending boreholes created by the various ultra-short radius lateral drilling procedures. The flow blocking materials can be pumped into the target zone in a single or in multiple stages. For example, one might pump materials of varying properties or viscosities in order to emplace them at different depths within the formation or to provide varying resistance to flow at varying depths in the reservoir. In certain cases, the pumping system can entail coiled tubing. In another cases the impermeable material can be delivered by way of upset tubing or production tubing.

A further benefit to the methods disclosed herein is that they better harness the drive of the reservoir to push the desired hydrocarbons to the wellbore. With the more favorable near wellbore pressure gradient that has been created, the reservoir drive can now be more effectively utilized. For example, a well that produced 5 barrels of oil and 45 barrels of water per day, produces 50 barrels of fluid per day. If this solution results in that well producing only 30 barrels of fluid per day, but if that mix is was more favorably disposed like 1:2 water to oil, than the operator would now only be have to content with 10 barrels of water, while getting to enjoy an increase to 20 barrels of oil per day. The results would be even better if they can maintain current total fluid production and benefit from the more favorable water to oil ratio.

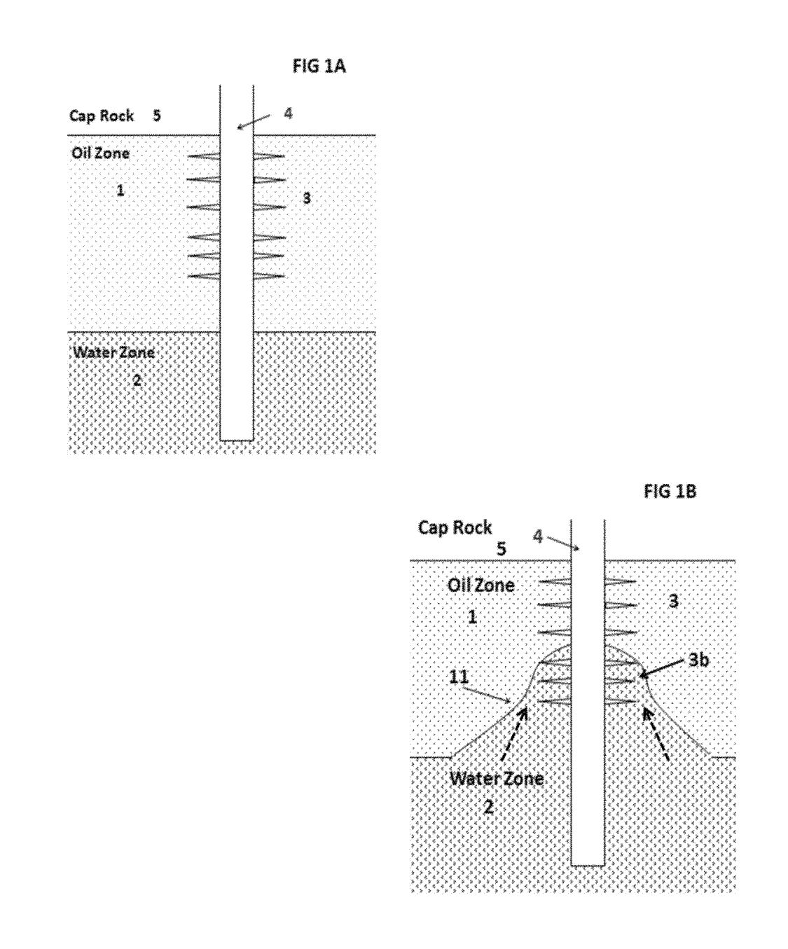

Now to discuss the drawings provided. FIG. 1A illustrates a typical hydrocarbon producing zone (1) with an underlying water zone (2). In this case water coning has not taken effect as either the well has not been put on pump or the pumping rate is at or below the Critical Production Rate (CPR). As seen in the drawing the perforations (3) are only in contact with the desired hydrocarbon zone (1) and thus only hydrocarbons are being received inside the wellbore (4).

FIG. 1B however illustrates the same wellbore (4), perforations (3), hydrocarbon zone (1) and water zone (2) under the occurrence of water coning (11). In proximity to the wellbore (4) the water zone (2) has invaded the hydrocarbon zone (1) and also the perforations (3) that allow fluid to pass into the wellbore (4). Water coning (11) can occur over time or if the production rate overcomes the CPR. The operator may knowingly produce at a greater rate than the CPR or the assumed CPR could have been believed to be higher than it is in reality. As one can see the coning shape (11) of the invading water zone (2) not only increases water production but also decreases hydrocarbon production as it blocks a portion of the producing perforations (3).

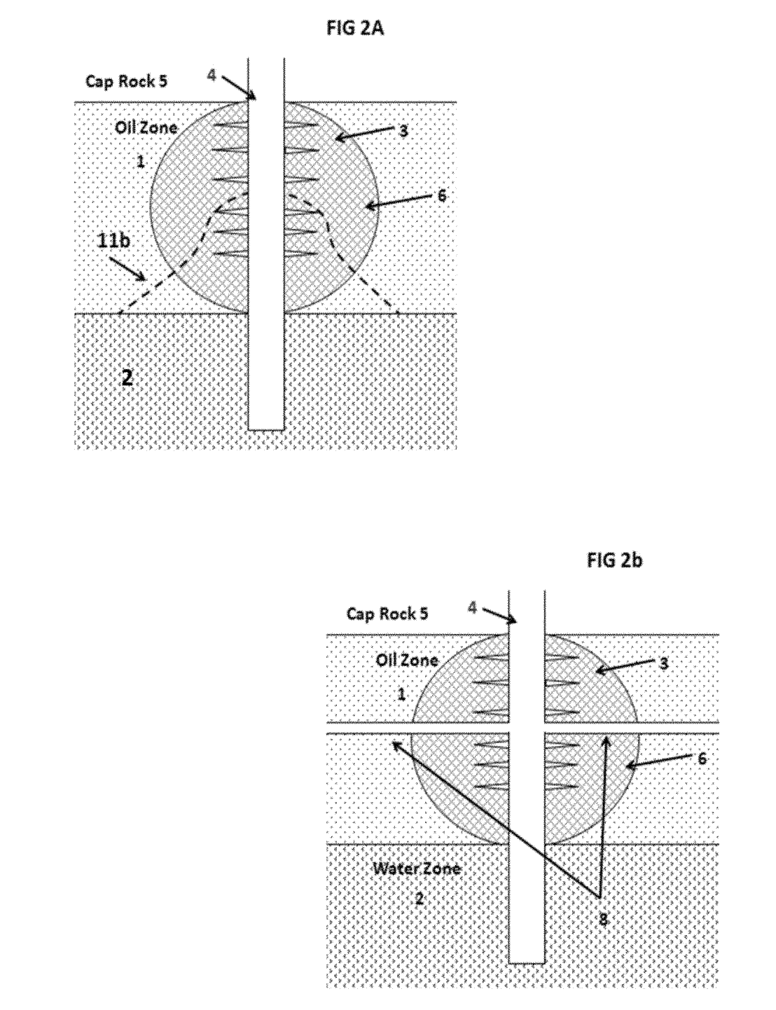

FIG. 2A illustrates the same wellbore as FIGS. 1A and 1B, except that an impermeable barrier (6) has been aggressively squeezed into the oil zone (1) through the perforations (3). The impermeable barrier (6) is now blocking flow into the well (4) from both the oil zone (1) and the water zone (2). Essentially, the well (4) has been “killed” and will not produce in this condition. The former boundary of the water-cone (no longer present) is shown by the dotted lines (11b).

FIG. 2B illustrates the same wellbore as FIG. 2A but radial boreholes (8) have been drilled through the impermeable barrier (6) that was placed in the oil zone (1), thereby re-establishing communication between the wellbore (4) and negating production from the formerly problematic water zone (2).

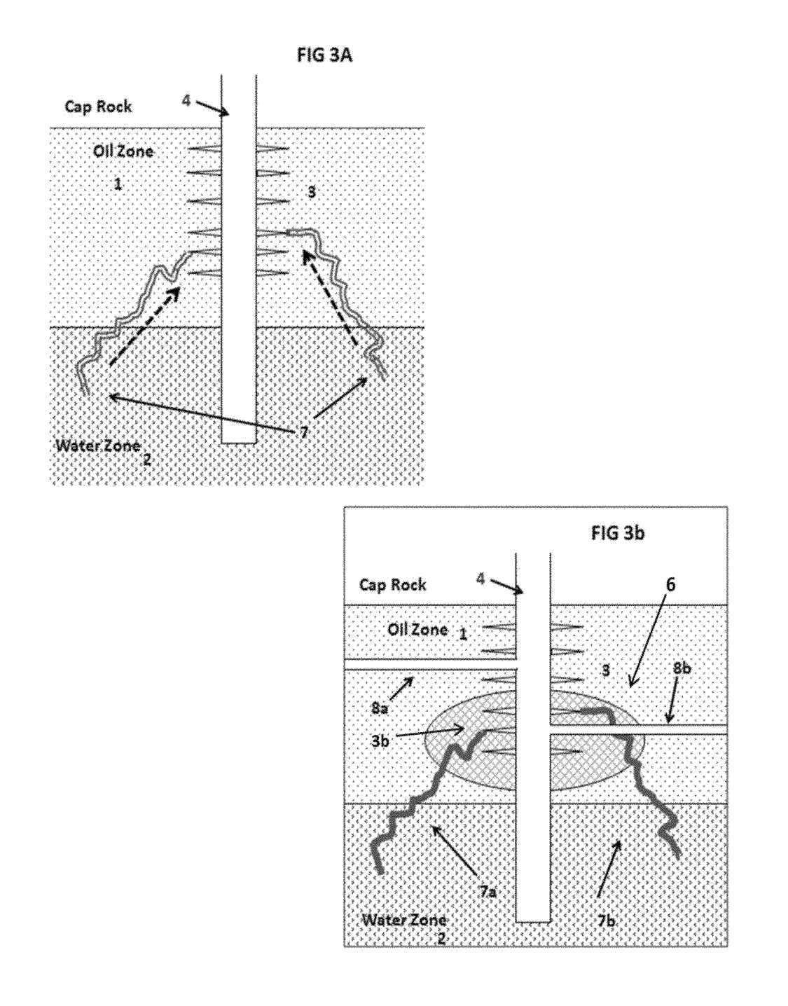

FIG. 3A illustrates an oil zone (1) subtended by a water zone (2) wherein two fractures (7) are channeling water (shown by dotted arrows) through the oil zone (1) and into the perforations (3).

FIG. 3B illustrates the same wellbore as FIG. 3A, but an impermeable barrier (6) has been squeezed out the lower perforations (3b) via an isolation packer (not shown). The impermeable barrier (6) has also flowed into a portion of the oil zone (1) and has filled the fractures (7a, 7b) so as to prevent the water zone (2) feeding into the lower perforations (3b). One radial borehole (8a) has been formed above the lower perforations (3b) and into the oil zone (1) and another radial borehole (8b) has been drilled into the oil zone (1) through the impermeable barrier (6) and one of the now-filled fractures (7b).

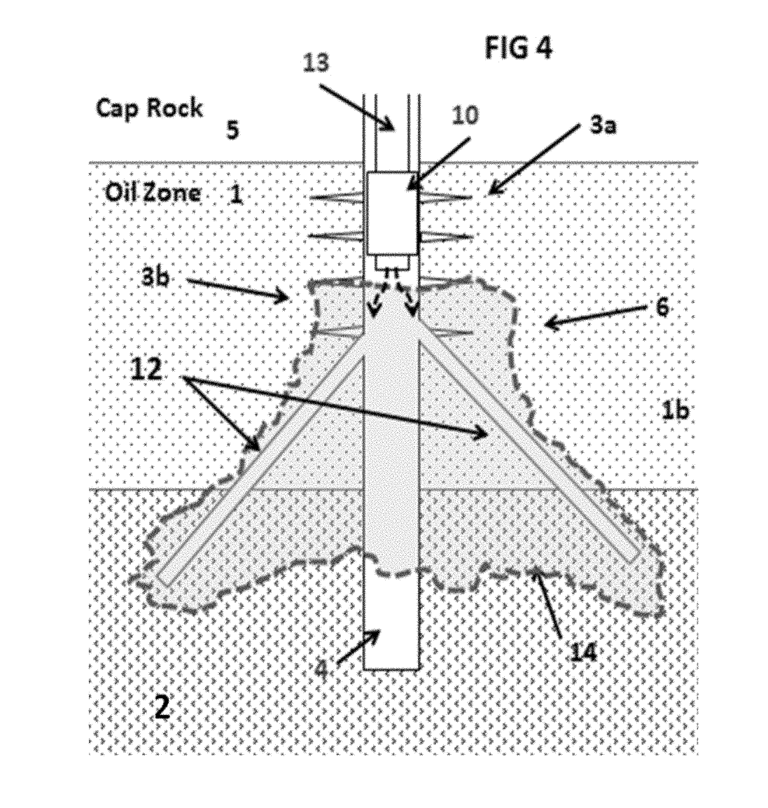

FIG. 4 illustrates a high permeability hydrocarbon zone (1) subtended by a problematic, nearby water zone (2). A set of injection laterals (12) have been drilled at and angle through lower portion of the oil zone (1b) and into the water zone (2). A isolation packer (10) has been activated in the wellbore (4) to isolate a set of lower perforations (3b) from an upper set of perforations (3a). A flow blocking material (6) has exited (see dotted arrows) the tubing (13) running through the packer (10). The flow blocking material (6) has exited the lower perforations (3b) and injection laterals (12) and has invaded into the matrix of the oil zone (1) and water zone (2) forming an impermeable boundary defined by dotted lines (14). Once the isolation packer (10) is removed, the well (4) production can occur from the upper perforations (3b) in the oil zone (1).

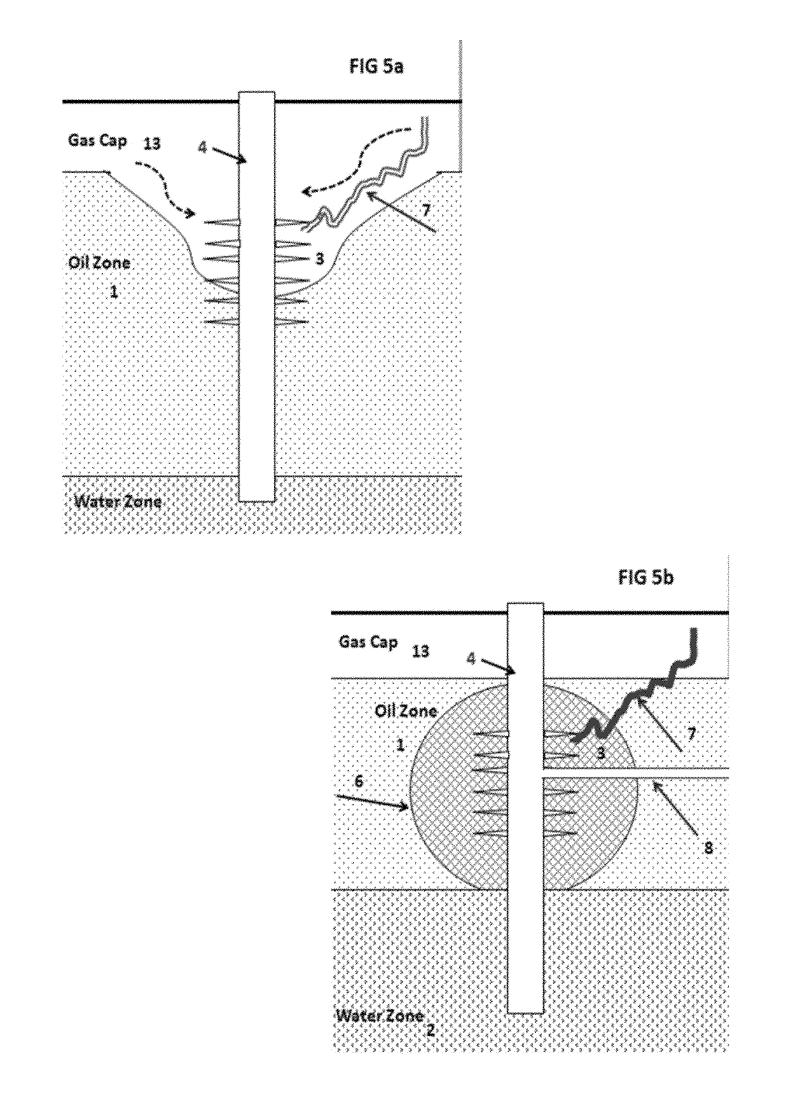

FIG. 5a illustrates a wellbore (4) with an oil zone (1) and perforations (3) that have been invaded (see dotted arrows) by the gas cap (13). There is also a problematic fracture (7) that runs between the gas cap (13) and the upper perforations (3) in the oil zone (1).

FIG. 5b illustrates the same wellbore as FIG. 5A. The gas cap (13) is not invading the perforations (3) because an impermeable barrier (6) has blocked the invading gas cap (13) and plugged the problematic fracture (7). A lateral borehole (8) has been drilled through the impermeable barrier (6) and into the oil zone (1) to re-establish production from the oil zone (1).

An embodiment of the present disclosure is a method to reduce water production into a wellbore from a subterranean formation that includes placing a blocking material into the subterranean formation, forming at least one radially-oriented borehole exiting the wellbore at between 45 to about 90 degrees from the wellbore into the subterranean formation, and then producing hydrocarbons through the at least one radially-oriented borehole. The blocking material may be placed in at least one fracture created by a hydraulic fracture job.

The at least one radially-oriented borehole can be formed through the blocking material placed within the subterranean formation or optionally can be formed above the blocking material placed within the subterranean formation. The method can also include forming one or more radially-oriented injection laterals into a portion of the subterranean formation prior to placing the blocking material. These radially-oriented injection laterals can be located in a lower portion of the subterranean formation to isolate a water bearing zone, or can be located in an upper portion of the subterranean formation to isolate a gas bearing zone, or optionally can be both. The method can include activation of at least one isolation packer to isolate a portion of the subterranean formation for blocking material placement.

The blocking material can be a gel, gellants, cements, linear polymers, cross-linked polymers, waxes, microbes, relative permeability modifiers, rheology modifiers, clay swelling fluids, epoxies, or combinations thereof. The blocking material can be activated by virtue of an action such as: the passage of time, changes in pH, changes in pressure, changes in temperature, contact with another material that is present in the subterranean formation, contact with another material that is placed into the subterranean formation, and combinations thereof.

The radially-oriented borehole exiting the wellbore at between 45 to about 90 degrees from the wellbore into the subterranean formation can be formed by mechanical drilling, high pressure fluid jetting, dissolving of the rock material by chemical means, hydro-slotting, ballistics, explosives, exothermic reactions, lasers, or combinations thereof. The wellbore in the subterranean formation can be a vertical well, a slant well, a horizontal well, or combinations thereof

The method can include pumping blocking materials of varying viscosities to varying depths of penetration into the subterranean formation. The method can include pumping blocking materials of varying water permeability reduction to varying depths of penetration into the subterranean formation. The blocking material can be delivered into the subterranean formation by pumping through a tubing string and packer.

An alternate embodiment of the present disclosure is a method to reduce water production into a wellbore from a subterranean formation by forming one or more radially-oriented injection laterals into a portion of the subterranean formation, inserting a tubing string and isolation packer within the wellbore, pumping a blocking material through the tubing string and isolation packer, placing the blocking material into the subterranean formation, activating the blocking material, forming at least one radially-oriented borehole exiting the wellbore at between 45 to about 90 degrees from the wellbore into the subterranean formation and producing hydrocarbons through the at least one radially-oriented borehole.

The blocking material can be a gel, gellants, cements, linear polymers, cross-linked polymers, waxes, microbes, relative permeability modifiers, rheology modifiers, clay swelling fluids, epoxies, or combinations thereof. The blocking material can be activated by virtue of an action such as: the passage of time, changes in pH, changes in pressure, changes in temperature, contact with another material that is present in the subterranean formation, contact with another material that is placed into the subterranean formation, and combinations thereof.

The radially-oriented borehole can be formed by mechanical drilling, high pressure fluid jetting, dissolving of the rock material by chemical means, hydro-slotting, ballistics, explosives, exothermic reactions, lasers, or combinations thereof. The wellbore in the subterranean formation can be a vertical well, a slant well, a horizontal well, or combinations thereof. The method can include pumping blocking materials of varying viscosities to varying depths of penetration into the subterranean formation. The method can include pumping blocking materials of varying water permeability reduction to varying depths of penetration into the subterranean formation. The blocking material can be delivered into the subterranean formation by pumping through a tubing string and packer.

The various embodiments of the present disclosure can be joined in combination with other embodiments of the disclosure and the listed embodiments herein are not meant to limit the disclosure. All combinations of various embodiments of the disclosure are enabled, even if not given in a particular example herein.

While illustrative embodiments have been depicted and described, modifications thereof can be made by one skilled in the art without departing from the scope of the disclosure. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted. While compositions and methods are described in terms of “comprising,” “containing,” or “including” various components or steps, the compositions and methods can also “consist essentially of or “consist of the various components and steps. Also, the terms in the claims have their plain, ordinary meaning unless otherwise explicitly and clearly defined by the patentee.

Depending on the context, all references herein to the “disclosure” may in some cases refer to certain specific embodiments only. In other cases it may refer to subject matter recited in one or more, but not necessarily all, of the claims. While the foregoing is directed to embodiments, versions and examples of the present disclosure, which are included to enable a person of ordinary skill in the art to make and use the disclosures when the information in this patent is combined with available information and technology, the disclosures are not limited to only these particular embodiments, versions and examples.

Numerous other modifications, equivalents, and alternatives, will become apparent to those skilled in the art once the above disclosure is fully appreciated. While embodiments of the disclosure have been shown and described, modifications thereof can be made by one skilled in the art without departing from the teachings of this disclosure. The embodiments described herein are exemplary only, and are not intended to be limiting. Many variations and modifications of the disclosure disclosed herein are possible and are within the scope of the disclosure.

Use of the term “optionally” with respect to any element of a claim is intended to mean that the subject element is required, or alternatively, is not required. Both alternatives are intended to be within the scope of the claim. It is intended that the following claims be interpreted to embrace all such modifications, equivalents, and alternatives where applicable. Other and further embodiments, versions and examples of the disclosure may be devised without departing from the basic scope thereof and the scope thereof is determined by the claims that follow.

1. A method to reduce water production into a wellbore from a subterranean formation, said method comprising:
placing a blocking material into the subterranean formation via the wellbore;
forming at least one radially-oriented borehole exiting the wellbore at between 45 to about 90 degrees from the wellbore into the subterranean formation; and
producing hydrocarbons through the at least one radially-oriented borehole.

2. The method of claim 1 further comprising: placing said blocking material in at least one fracture created by a hydraulic fracture job.

3. The method of claim 1, wherein the at least one radially-oriented borehole is formed through the blocking material placed within the subterranean formation.

4. The method of claim 1, wherein the at least one radially-oriented borehole is formed above the blocking material placed within the subterranean formation.

5. The method of claim 1 further comprising: forming one or more radially-oriented injection laterals into a portion of the subterranean formation prior to placing the blocking material.

6. The method of claim 5, wherein at least one of the radially-oriented injection laterals formed into a portion of the subterranean formation prior to placing the blocking material is located in a lower portion of the subterranean formation to isolate a water bearing zone.

7. The method of claim 5, wherein at least one of the radially-oriented injection laterals formed into a portion of the subterranean formation prior to placing the blocking material is located in an upper portion of the subterranean formation to isolate a gas bearing zone.

8. The method of claim 1 further comprising: activation of at least one isolation packer to isolate a portion of the subterranean formation for blocking material placement.

9. The method of claim 1, wherein the blocking material is selected from the group consisting of: gel, gellants, cements, linear polymers, cross-linked polymers, waxes, microbes, relative permeability modifiers, rheology modifiers, clay swelling fluids, epoxies and combinations thereof

10. The method of claim 9, wherein the blocking material is activated by virtue of an action selected from the group consisting of: the passage of time, changes in pH, changes in pressure, changes in temperature, contact with another material that is present in the subterranean formation, contact with another material that is placed into the subterranean formation, and combinations thereof.

11. The method of claim 1, wherein the at least one radially-oriented borehole exiting the wellbore at between 45 to about 90 degrees from the wellbore into the subterranean formation is formed by a method selected from the group consisting of:
mechanical drilling, high pressure fluid jetting, dissolving of the rock material by chemical means, hydro-slotting, ballistics, explosives, exothermic reactions, lasers, and combinations thereof.

12. The method of claim 1, wherein the wellbore in the subterranean formation is selected from the group consisting of: a vertical well, a slant well, a horizontal well, and combinations thereof.

13. The method of claim 1 further comprising: pumping blocking materials of varying viscosities to varying depths of penetration into the subterranean formation.

14. The method of claim 1 further comprising: pumping blocking materials of varying water permeability reduction to varying depths of penetration into the subterranean formation.

15. The method of claim 1 further comprising: delivering the blocking material into the subterranean formation by pumping through a tubing string and packer.

16. A method to reduce water production into a wellbore from a subterranean formation, said method comprising:
forming one or more radially-oriented injection laterals into a portion of the subterranean formation;
inserting a tubing string and isolation packer within the wellbore;
pumping a blocking material through the tubing string and isolation packer;
placing the blocking material into the subterranean formation;
activating the blocking material;
forming at least one radially-oriented borehole exiting the wellbore at between 45 to about 90 degrees from the wellbore into the subterranean formation; and
producing hydrocarbons through the at least one radially-oriented borehole.

17. The method of claim 16, wherein the blocking material is selected from the group consisting of: gel, gellants, cements, linear polymers, cross-linked polymers, waxes, microbes, relative permeability modifiers, clay swelling fluids, epoxies and combinations thereof

18. The method of claim 16, wherein the blocking material is activated by virtue of an action selected from the group consisting of: the passage of time, changes in pH, changes in pressure, changes in temperature, contact with another material that is present in the subterranean formation, contact with another material that is placed into the subterranean formation, and combinations thereof.

19. The method of claim 16, wherein the at least one radially-oriented borehole exiting the wellbore at between 45 to about 90 degrees from the wellbore into the subterranean formation is formed by a method selected from the group consisting of:
mechanical drilling, high pressure fluid jetting, dissolving of the rock material by chemical means, hydro-slotting, ballistics, explosives, exothermic reactions, lasers, and combinations thereof.

20. The method of claim 16 further comprising: pumping blocking materials of varying water permeability reduction to varying depths of penetration into the subterranean formation.
